(19) United States
(12) Patent Application Publication
(10) Pub. No.: US 2016/0222182 A1
(43) Pub. Date: Aug. 4, 2016

(54) ETHYLENE-PROPYLENE-DIENE RUBBER FOAMED MATERIAL AND SEALING MATERIAL

(71) Applicant: NITTO DENKO CORPORATION, Osaka (JP)

(72) Inventors: Yuuki FUKUDA, Osaka (JP); Takumi KOUSAKA, Osaka (JP)

(73) Assignee: NITTO DENKO CORPORATION, Osaka (JP)

(21) Appl. No.: 15/013,235

(22) Filed: Feb. 2, 2016

(30) Foreign Application Priority Data
Feb. 3, 2015 (JP) 2015-019668

(51) Int. Cl. C08J 9/00; C08J 9/08; C08J 9/10

(52) U.S. Cl. CPC C08J 9/0061; C08J 9/103; C08J 9/08; C08J 2203/04; C08J 2203/02; C08J 2323/16; C08J 2423/16; C08J 2423/06; C08J 2423/08

(57) ABSTRACT

An ethylene-propylene-diene rubber foamed material is obtained by foaming a rubber composition containing an ethylene-propylene-diene rubber and a thermoplastic resin having a melting point of 60 to 140° C. The thermoplastic resin content with respect to 100 parts by mass of the ethylene-propylene-diene rubber is 5 to 50 parts by mass and the ethylene-propylene-diene rubber includes an ethylene-propylene-diene rubber having a diene amount of 4.0 mass % or more.

### CROSS-REFERENCE TO RELATED APPLICATION

The present application claims priority from Japanese Patent Application No. 2015-019668 filed on Feb. 3, 2015, the contents of which are hereby incorporated by reference into this application.

### BACKGROUND OF THE INVENTION

1. Field of the Invention

The present invention relates to an ethylene-propylene-diene rubber foamed material and a sealing material, to be specific, to an ethylene-propylene-diene rubber foamed material and a sealing material including the ethylene-propylene-diene rubber foamed material.

2. Description of Related Art

As a sealing material for various industrial products, an EPDM foamed material obtained by foaming an ethylene-propylene-diene rubber (hereinafter, may be referred to as an EPDM) has been conventionally known.

The EPDM foamed material is generally produced by foaming an EPDM with a foaming agent and cross-linking the EPDM with a cross-linking agent.

As such an EPDM foamed material, for example, an EPDM foamed material obtained by foaming a rubber composition containing an EPDM, a quinoid cross-linking agent, an organic peroxide cross-linking agent, a foaming agent, and the like has been proposed (ref: for example, Japanese Unexamined Patent Publication No. 2013-79366).

### SUMMARY OF THE INVENTION

The EPDM foamed material is required to be a foamed material having a higher foaming ratio. As a result, the EPDM foamed material has low density.

However, there is a disadvantage that when the density of the EPDM foamed material is reduced, the flexibility thereof is improved, so that a restoring force at the time of release of a compressive force is reduced and thus, a permanent compression set is increased. When the permanent compression set is increased, a sag occurs at the time of its use and the sealing properties are substantially reduced.

It is an object of the present invention to provide an ethylene-propylene-diene rubber foamed material that has low density and a low permanent compression set, and a sealing material that includes the ethylene-propylene-diene rubber foamed material.

The present invention [1] includes an ethylene-propylene-diene rubber foamed material obtained by foaming a rubber composition containing an ethylene-propylene-diene rubber and a thermoplastic resin having a melting point of 60 to 140° C., wherein the thermoplastic resin content with respect to 100 parts by mass of the ethylene-propylene-diene rubber is 5 to 50 parts by mass and the ethylene-propylene-diene rubber includes an ethylene-propylene-diene rubber having a diene amount of 4.0 mass % or more.

The present invention [2] includes the ethylene-propylene-diene rubber foamed material described in [1], wherein the content ratio of the ethylene-propylene-diene rubber having the diene amount of 4.0 mass % or more in the ethylene-propylene-diene rubber is 20 mass % or more.

The present invention [3] includes the ethylene-propylene-diene rubber foamed material described in [1] or [2], wherein the ethylene-propylene-diene rubber having the diene amount of 4.0 mass % or more is an ethylene-propylene-diene rubber having a diene amount of 4.0 mass % or more and less than 7.0 mass %.

The present invention [4] includes the ethylene-propylene-diene rubber foamed material described in any one of [1] to [3], wherein the ethylene-propylene-diene rubber includes an ethylene-propylene-diene rubber having the diene amount of 4.0 mass % or more and less than 7.0 mass % and an ethylene-propylene-diene rubber having a diene amount of 7.0 mass % or more and 15.0 mass % or less.

The present invention [5] includes the ethylene-propylene-diene rubber foamed material described in [4], wherein the content ratio of the ethylene-propylene-diene rubber having the diene amount of 4.0 mass % or more and less than 7.0 mass % in the ethylene-propylene-diene rubber is 20 mass % or more and the content ratio of the ethylene-propylene-diene rubber having the diene amount of 7.0 mass % or more and 15.0 mass % or less in the ethylene-propylene-diene rubber is 20 mass % or more.

The present invention [6] includes the ethylene-propylene-diene rubber foamed material described in [4] or [5], wherein the mass ratio of the ethylene-propylene-diene rubber having the diene amount of 4.0 mass % or more and less than 7.0 mass % to the ethylene-propylene-diene rubber having the diene amount of 7.0 mass % or more and 15.0 mass % or less is 30:70 to 100:0.

The present invention [7] includes the ethylene-propylene-diene rubber foamed material described in any one of [4] to [6], wherein the ethylene-propylene-diene rubber having the diene amount of 7.0 mass % or more and 15.0 mass % or less has a long chain branching structure.

The present invention [8] includes the ethylene-propylene-diene rubber foamed material described in any one of [1] to [7], wherein the ethylene-propylene-diene rubber having the diene amount of 4.0 mass % or more is obtained by a copolymer of ethylene, propylene, and dienes and the dienes contain 5-ethylidene-2-norbornene.

The present invention [9] includes the ethylene-propylene-diene rubber foamed material described in any one of [1] to [8], wherein the rubber composition further contains 40 parts by mass or more of a foaming agent with respect to 100 parts by mass of the ethylene-propylene-diene rubber.

The present invention [10] includes the ethylene-propylene-diene rubber foamed material described in any one of [1] to [9], wherein a 50% compressive load value is 0.03 to 0.50 N/cm² and an 80% compressive load value is 0.10 to 2.00 N/cm².

The present invention [11] includes a sealing material including the ethylene-propylene-diene rubber foamed material described in any one of [1] to [10] and a pressure-sensitive adhesive layer provided on at least one surface of the ethylene-propylene-diene rubber foamed material.

The ethylene-propylene-diene rubber foamed material of the present invention is obtained by foaming the rubber composition containing S to 50 parts by mass of the thermoplastic resin having the melting point of 60 to 140° C. with respect to 100 parts by mass of the ethylene-propylene-diene rubber including the ethylene-propylene-diene rubber having the diene amount of 4.0 mass % or more. Thus, the ethylene-propylene-diene rubber foamed material of the present invention has an excellent permanent compression set, while having low density.

According to the sealing material of the present invention, the above-described ethylene-propylene-diene rubber foamed material is included, so that a gap between members can be surely filled with and sealed by the sealing material.

### BRIEF DESCRIPTION OF THE DRAWINGS

FIG. 1 shows a schematic configuration view illustrating one embodiment of a scaling material of the present invention.

### DETAILED DESCRIPTION OF THE INVENTION

An ethylene-propylene-diene rubber (hereinafter, may be referred to as an EPDM) foamed material of the present invention is obtained by foaming a rubber composition containing the EPDM and a thermoplastic resin.

The EPDM is a rubber obtained by copolymerization of ethylene, propylene, and dienes. The further copolymerization of the dienes, in addition to the ethylene and the propylene, allows introduction of an unsaturated bond and enables cross-linking with a cross-linking agent to be described later.

Examples of the dienes include 5-ethylidene-2-norbornene, 1,4-hexadiene, and dicyclopentadiene. These dienes may be used alone or in combination of two or more.

The EPDM includes an EPDM having a diene amount (diene content) of 4.0 mass % or more (hereinafter, also referred to as a “high diene EPDM”).

To be more specific, in the present invention, the high diene EPDM is divided into an ethylene-propylene-diene rubber having a diene amount of 4.0 mass % or more and less than 7.0 mass % (hereinafter, also referred to as a “first EPDM”) and an ethylene-propylene-diene rubber having a diene amount of 7.0 mass % or more and 15.0 mass % or less (hereinafter, also referred to as a “second EPDM”). The diene amount can be obtained by the mass ratio of raw materials (monomers). The diene amount can be also obtained in accordance with ASTM D 6047.

The first EPDM has a diene amount of 4.0 mass % or more, or preferably 4.5 mass % or more, and less than 7.0 mass %, or preferably 6.0 mass % or less.

When the EPDM includes the first EPDM, as the dienes in the first EPDM, of the above-described dienes, preferably, 5-ethylidene-2-norbornene is used. In this manner, the EPDM foamed material having low density and a low permanent compression set can be surely obtained.

The first EPDM is, for example, produced by a known method such as polymerization with a catalyst such as a Ziegler-Natta catalyst, a metallocene catalyst, and a vanadium catalyst.

The first EPDM has a Mooney viscosity of, for example, 1 (ML 1+4, at 125° C.) or more, preferably 10 (ML 1+4, at 125° C.) or more, or more preferably 35 (ML 1+4, at 125° C.) or more, and, for example, 100 (ML 1+4, at 125° C.) or less, or preferably 50 (ML 1+4, at 125° C.) or less.

The second EPDM has a diene amount of 7.0 mass % or more, or preferably 9.0 mass % or more, and 15.0 mass % or less, or preferably 12.0 mass % or less.

When the EPDM includes the second EPDM, as the dienes in the second EPDM, of the above-described dienes, preferably, 5-ethylidene-2-norbornene is used. In this manner, the EPDM foamed material having low density and a low permanent compression set can be surely obtained.

The second EPDM preferably has a long chain branching structure. When the second EPDM has the long chain branching structure, the elongational viscosity is increased due to the entanglement of the side chain, so that the rubber composition can be excellently foamed and the density of the EPDM foamed material can be further reduced.

As a method for introducing the long chain branching structure into the EPDM, preferably, polymerization with a metallocene catalyst is used.

The second EPDM has a Mooney viscosity of, for example, 1 (ML 1+4, at 100° C.) or more, or preferably 10 (ML 1+4, at 100° C.) or more, and, for example, 100 (ML 1+4, at 100° C.) or less, or preferably less than 35 (ML 1+4, at 100° C.).

In the present invention, at least one of the first EPDM and the second EPDM may be included. Preferably, at least the first EPDM is included, or more preferably, the first EPDM and the second EPDM are included in combination.

The first EPDM content in the EPDM is, for example, 20 mass % or more, preferably 30 mass % or more, more preferably 40 mass % or more, further more preferably 60 mass % or more, or particularly preferably 100 mass %.

The second EPDM content in the EPDM is, for example, 0 mass % or more, preferably 10 mass % or more, or more preferably 20 mass % or more, and, for example, 80 mass % or less, preferably 70 mass % or less, more preferably 60 mass % or less, or further more preferably 40 mass % or less.

When as the EPDM, the first EPDM and the second EPDM are used in combination, the mass ratio of the first EPDM to the second EPDM is, for example, 20:80 to 100:0, preferably 30:70 to 100:0, more preferably 30:70 to 90:10, further more preferably 40:60 to 90:10, or particularly preferably 60:40 to 80:20. By setting the mass ratio of the first EPDM to the second EPDM within the above-described range, particularly, by allowing the first EPDM to be rich, the EPDM foamed material having low density and a low permanent compression set can be surely obtained.

When the EPDM includes 100 mass % of the first EPDM, preferably, as the first EPDM, a high viscosity EPDM having 35 (ML 1+4, at 125° C.) or more (preferably, 100 (ML 1+4, at 125° C.) or less) and a low viscosity EPDM having less than 35 (ML 1+4, at 125° C.) (preferably, 1 (ML 1+4, at 125° C.) or more) are used in combination. The mass ratio of the high viscosity EPDM to the low viscosity EPDM is, for example, 10:90 to 90:10, or preferably 30:70 to 70:30.

The EPDM can also include an EPDM having a diene amount of 0.5 mass % or more and less than 4.0 mass % (hereinafter, also referred to as a “low diene EPDM”) in addition to the high diene EPDM. In this manner, the low permanent compression set of the EPDM foamed material can be excellent.

The low diene EPDM has a diene amount of preferably 2.0 mass % or more and 3.0 mass % or less. In this manner, the low permanent compression set for a short period of time of the EPDM foamed material can be excellent.

As the dienes in the low diene EPDM, of the above-described dienes, preferably, 5-ethylidene-2-norbornene is used.

The low diene EPDM is, for example, produced by the above-described catalyst.

The low diene EPDM has a Mooney viscosity of, for example, 1 (ML 1+4, at 100° C.) or more, or preferably 10 (ML 1+4, at 100° C.) or more, and, for example, 100 (ML 1+4, at 100° C.) or less, or preferably less than 35 (ML 1+4, at 100° C.).

When the EPDM includes the low diene EPDM, the low diene EPDM content in the EPDM is, for example, 0 mass % or more, preferably 10 mass % or more, or more preferably 30 mass % or more, and, for example, 90 mass % or less, or preferably 70 mass % or less.

The EPDM (the total amount of the high diene EPDM and the low diene EPDM) content in the rubber composition is, for example, 5 mass % or more, or preferably 10 mass % or more, and, for example, 80 mass % or less, preferably 50 mass % or less, or more preferably 40 mass % or less.

The thermoplastic resin has a melting point of 60° C. or more, preferably 80° C. or more, more preferably 85° C. or more, further more preferably 95° C. or more, or particularly preferably 100° C. or more, and 140° C. or less, preferably 130° C. or less, more preferably 120° C. or less, further more preferably 115° C. or less, or particularly preferably less than 110° C. By setting the melting point of the thermoplastic resin contained in the rubber composition within the above-described range, defective dispersion of the pressure can be suppressed and in a portion that requires a normal temperature or heat resistance, an excellent permanent compression set is developed, so that a compressed foamed material can be restored. Also, the low density of the EPDM foamed material is possible.

The melting point can be obtained in accordance with JIS K 6922-2 or JIS K 7121 by differential scanning calorimetry (DSC).

Examples of the thermoplastic resin include polyethylene (low density polyethylene, high density polyethylene), polypropylene, an ethylene-vinyl acetate copolymer (EVA), an acrylic polymer (for example, poly(meth)acrylate alkyl ester and the like), polyvinyl chloride, polyvinyl acetate, polyamide, polyester, chlorinated polyethylene, a urethane polymer, a styrene polymer, and a silicone polymer.

These thermoplastic resins may be used alone or in combination of two or more.

In view of low density and low permanent compression set of the EPDM foamed material, preferably, polyethylene and EVA are used. Furthermore, in view of dispersibility, heat resistance, and weather resistance, more preferably, polyethylene is used, or particularly preferably, low density polyethylene is used.

The density of the polyethylene can be obtained in accordance with either JIS K 6922-1 or JIS K 7112. The low density polyethylene has density of less than 940 kg/m³ and the high density polyethylene has density of 940 kg/m³ or more.

The thermoplastic resin has a melt mass flow rate (MFR) of, for example, 1 g/10 min or more, or preferably 25 g/10 min or more, and, for example, 200 g/10 min or less, or preferably less than 100 g/10 min. In this manner, the permanent compression set and a compressive load value of the EPDM foamed material can be further reduced.

The MFR can be obtained in accordance with JIS K 6922 (either JIS K 6922-1 or JIS K 6922-2).

The thermoplastic resin content with respect to 100 parts by mass of the EPDM is 5 parts by mass or more, preferably 10 parts by mass or more, or more preferably 15 parts by mass or more, and 50 parts by mass or less, preferably 35 parts by mass or less, or more preferably 25 parts by mass or less. When the thermoplastic resin content with respect to the EPDM is below the above-described lower limit, the permanent compression set of the EPDM foamed material is increased and a restoring force at the time of release of a compressive force is reduced.

Meanwhile, when the thermoplastic resin content is above the above-described upper limit, an expansion ratio is reduced and the compressive load value is increased.

The rubber composition preferably contains a cross-linking agent and a foaming agent.

Examples of the cross-linking agent include sulfur; sulfur compounds such as 4,4′-dithiodimorpholine; quinoid compounds such as p-quinonedioxime, p,p′-dibenzoylquinonedioxime, and poly-p-dinitrosobenzene; organic peroxides such as dicumyl peroxide, dimethyl di(t-butylperoxy)hexane, 1,1-di(t-butylperoxy)cyclohexane, and α,α′-di(t-butylperoxy)diisopropyl benzene; nitroso compounds such as p-dinitrosobenzene; formaldehyde resins such as alkylphenol-formaldehyde resin and melamine-formaldehyde condensate; and ammonium salts such as ammonium benzoate. Examples thereof also include selenium, magnesium oxide, lead monoxide, and polyamine.

These cross-linking agents may be used alone or in combination of two or more.

In view of low density, preferably, sulfur and sulfur compounds are used, or more preferably, sulfur is used.

The cross-linking agent content with respect to 100 parts by mass of the EPDM is, for example, 0.1 parts by mass or more, or preferably 0.5 parts by mass or more, and, for example, 20 parts by mass or less, or preferably 10 parts by mass or less.

Examples of the foaming agent include an organic foaming agent and an inorganic foaming agent.

Examples of the organic foaming agent include azo foaming agents such as azodicarbonamide (ADCA), barium azodicarboxylate, azobisisobutylonitrile (AIBN), azocyclohexylnitrile, and azodiaminobenzene; N-Nitroso foaming agents such as N,N′-dinitrosopentamethylenetetramine (DTP), N,N′-dimethyl-N,N′-dinitrosoterephthalamide, and trinitrosotrimethyltriamine; hydrazide foaming agents such as 4,4′-oxybis(benzenesulfonylhydrazide) (OBSH), paratoluenesulfonylhydrazide, diphenylsulfone-3,3′-disulfonylhydrazide, 2,4-toluenedisulfonylhydrazide, p,p-bis(benzenesulfonylhydrazide)ether, benzene-1,3-disulfonylhydrazide, and allylbis(sulfonylhydrazide); semicarbazide foaming agents such as p-toluylenesulfonylsemicarbazide and 4,4′-oxybis(benzenesulfonylsemicarbazide); fluorinated alkane foaming agents such as trichloromonofluoromethane and dichloromonofluoromethane; triazole foaming agents such as 5-morpholyl-1,2,3,4-thiatriazole; and other known organic foaming agents. Preferably, azo foaming agents are used.

Also, examples of the organic foaming agent include thermally expansive fine particles in which a heat-expandable substance is encapsulated in a microcapsule. An example of the thermally expansive fine particles can include a commercially available product such as Microsphere (trade name, manufactured by Matsumoto Yushi-Seiyaku Co., Ltd.).

Examples of the inorganic foaming agent include hydrogencarbonate such as sodium hydrogen carbonate and ammonium hydrogen carbonate; carbonate such as sodium carbonate and ammonium carbonate; nitrite such as sodium nitrite and ammonium nitrite; borohydride salt such as sodium borohydride; azides; and other known inorganic foaming agents. Preferably, hydrogencarbonate is used.

These foaming agents may be used alone or in combination of two or more.

Preferably, an organic foaming agent is used, or more preferably, an organic foaming agent and an inorganic foaming agent are used in combination. In this manner, the further lower density EPDM foamed material can be obtained.

The foaming agent content with respect to 100 parts by mass of the EPDM is, for example, 5 parts by mass or more, preferably 20 parts by mass or more, or more preferably 40 parts by mass or more, and, for example, 70 parts by mass or less, or preferably 50 parts by mass or less. In this manner, the permanent compression set of the EPDM foamed material is excellent. When the organic foaming agent and the inorganic foaming agent are used in combination, the mass ratio of the inorganic foaming agent with respect to 100 parts by mass of the organic foaming agent is, for example, 0.5 parts by mass or more, preferably 1 part by mass or more, or more preferably 5 parts by mass or more, and, for example, 20 parts by mass or less, or preferably 10 parts by mass or less.

More preferably, the rubber composition contains a cross-linking auxiliary and a foaming auxiliary.

Examples of the cross-linking auxiliary include thiazoles such as dibenzothiazyl disulfide and 2-mecrcaptobenzothiazole; thioureas such as diethylthiourea, trimethylthiourea, and dibutylthiourea; dithiocarbamates such as sodium dimethyldithiocarbamate, sodium diethyldithiocarbamate, zinc dimethyldithiocarbamate, zinc diethyldithiocarbanate, and zinc dibenzyldithiocarbamate; guanidines such as diphenylguanidine and di-o-tolylguanidine; sulfenamides such as benzothiazyl-2-diethylsulfenamide and N-cyclohexyl-2-benzothiazylsulfenamide; thiurams such as tetramethylthiuram monosulfide, tetramethylthiuram disulfide, and tetrabenzylthiuram disulfide; xanthogens such as sodium isopropylxanthate and zinc isopropylxanthate; aldehyde ammonias such as acetaldehyde ammonia and hexamethylene tetramine; aldehyde amines such as n-butylaldehyde aniline and butylaldchide monobutylamine; and alcohols such as ethanol, ethylene glycol, glycerine, polyethylene glycol, and polypropylene glycol.

These cross-linking auxiliaries may be used alone or in combination of two or more.

As the cross-linking auxiliary, preferably, thiazoles, thioureas, and dithiocarbamates are used, or more preferably, thiazoles, thioureas, and dithiocarbamates are used in combination.

The cross-linking auxiliary content with respect to 100 parts by mass of the EPDM is, for example, 0.1 parts by mass or more, or preferably 0.5 parts by mass or more, and, for example, 20 parts by mass or less, or preferably 10 parts by mass or less.

Examples of the foaming auxiliary include a urea foaming auxiliary, a salicylic acid foaming auxiliary, a benzoic acid foaming auxiliary, and a metal oxide (for example, zinc oxide and the like).

These foaming auxiliaries may be used alone or in combination of two or more.

Preferably, a urea foaming auxiliary and a metal oxide are used, or more preferably, a urea foaming auxiliary and a metal oxide are used in combination.

The foaming auxiliary content with respect to 100 parts by mass of the EPDM is, for example, 1 part by mass or more, or preferably 3 parts by mass or more, and, for example, 20 parts by mass or less, or preferably 15 parts by mass or less. When the urea foaming auxiliary and the metal oxide are used in combination, the urea foaming auxiliary content with respect to 100 parts by mass of the metal oxide is, for example, 10 parts by mass or more, or preferably 50 parts by mass or more, and, for example, 200 parts by mass or less, or preferably 150 parts by mass or less.

The rubber composition can appropriately and selectively contain a processing auxiliary, a pigment, a filler, a softener, or the like as needed.

Examples of the processing auxiliary include a stearic acid and esters thereof and a zinc stearate. These processing auxiliaries may be used alone or in combination of two or more.

The processing auxiliary content with respect to 100 parts by mass of the EPDM is, for example, 0.1 parts by mass or more, or preferably 0.5 parts by mass or more, and, for example, 10 parts by mass or less, or preferably 5 parts by mass or less.

An example of the pigment includes carbon black. The pigment has an average particle size of, for example, 1 μm or more and 200 μm or less. These pigments may be used alone or in combination of two or more.

The pigment content with respect to 100 parts by mass of the EPDM is, for example, 1 part by mass or more, or preferably 2 parts by mass or more, and, for example, 50 parts by mass or less, or preferably 30 parts by mass or less.

Examples of the filler include inorganic fillers such as calcium carbonate, magnesium carbonate, silicic acid and salts thereof, clay, talc, mica powders, bentonite, silica, alumina, aluminum silicate, and aluminum powders; organic fillers such as cork; and other known fillers. These fillers may be used alone or in combination of two or more. Preferably, inorganic fillers are used, or more preferably calcium carbonate is used.

The filler content with respect to 100 parts by mass of the EPDM is, for example, 50 parts by mass or more, or preferably 100 parts by mass or more, and, for example, 500 parts by mass or less, or preferably 250 parts by mass or less.

Examples of the softener include drying oils, animal and vegetable oils (for example, linseed oil and the like), paraffin (for example, paraffin pellet and the like), asphalts (for example, blown asphalt and the like), petroleum oils (for example, paraffinic process oil, naphthenic process oil, aromatic process oil, and the like), low molecular weight polymers, and organic acid esters (for example, phthalic ester (for example, di-2-ethylhexyl phthalate (DOP) and dibutyl phthalate (DBP)), phosphate ester, higher fatty acid ester, alkyl sulfonate ester, and the like). These softeners may be used alone or in combination of two or more. Preferably, paraffin, asphalt, and petroleum oils are used.

The softener content with respect to 100 parts by mass of the EPDM is, for example, 10 parts by mass or more, or preferably 50 parts by mass or more, and, for example, 200 parts by mass or less, or preferably 100 parts by mass or less.

Furthermore, the rubber composition can contain a known additive at an appropriate proportion in accordance with its purpose and use as long as it does not damage the excellent effect of the EPDM foamed material to be obtained. Examples of the known additive include a polymer other than the above-described thermoplastic resin, a flame retardant, a tackifier, an oxidation inhibitor, an antioxidant, a colorant, and a fungicide.

Next, a method for producing an EPDM foamed material is described.

In order to produce the EPDM foamed material, first, the above-described components are blended to be kneaded by using a kneader, a mixer, a mixing roller, or the like, so that the rubber composition is kneaded as a kneaded material (kneading step).

In the kneading step, the components can be also kneaded, while being appropriately heated. Also, in the kneading step, for example, components other than a cross-linking agent, a cross-linking auxiliary, a foaming agent, and a foaming auxiliary are first kneaded to prepare a first kneaded material. Thereafter, a cross-linking agent, a cross-linking auxiliary, a foaming agent, and a foaming auxiliary are added to the first kneaded material to be kneaded, so that the rubber composition (second kneaded material) can be obtained.

The obtained rubber composition (kneaded material) is extruded into a sheet shape or the like by using an extruder (molding step) and the extruded rubber composition is heated to be foamed (foaming step).

A heat condition is appropriately selected in accordance with a cross-linking starting temperature of the cross-linking agent to be blended, a foaming temperature of the foaming agent to be blended, or the like. The rubber composition is preheated by using, for example, an oven with internal air circulation at, for example, 40° C. or more, or preferably 60° C. or more, and, for example, 200° C. or less, or preferably 160° C. or less, for, for example, 1 minute or more, or preferably 5 minutes or more, and, for example, 60 minutes or less, or preferably 40 minutes or less. After the preheating, the rubber composition is heated at, for example, 450° C. or less, or preferably 250° C. or less, and, for example, 100° C. or more, or preferably 160° C. or more, for, for example, 5 minutes or more, or preferably 10 minutes or more, and, for example, 80 minutes or less, or preferably 50 minutes or less.

According to the method for producing an EPDM foamed material, the EPDM foamed material having low density and a low permanent compression set can be easily and surely produced.

Also, the obtained rubber composition is extruded into a sheet shape by using an extruder, while being heated (molding step) (that is, a rubber composition sheet is produced) and the rubber composition in a sheet shape (rubber composition sheet) can be continuously cross-linked and foamed (foaming step).

According to this method, the EPDM foamed material can be produced with excellent production efficiency.

In this manner, the rubber composition is foamed and cross-linked, so that the EPDM foamed material can be obtained.

According to the method for producing an EPDM foamed material, the EPDM foamed material in a desired shape can be easily and surely produced with excellent production efficiency.

The obtained EPDM foamed material has a thickness of, for example, 0.1 mm or more, or preferably 1 mm or more, and, for example, 50 mm or less, or preferably 45 mm or less.

The EPDM foamed material has, for example, an open cell structure (open cell ratio of 100%) or a semi-open/semi-closed cell structure (open cell ratio of, for example, above 0%, or preferably 10% or more, and, for example, less than 100%, or preferably 98% or less).

Preferably, the EPDM foamed material has a semi-open/semi-closed cell structure. When the EPDM foamed material has a semi-open/semi-closed cell structure, improvement of the flexibility can be achieved and furthermore, improvement of the sealing properties of the EPDM foamed material with respect to a gap between members can be achieved.

The EPDM foamed material has an average cell size of, for example, 50 μm or more, preferably 100 μm or more, or more preferably 200 μm or more, and, for example, 1200 μm or less, preferably 1000 μm or less, or more preferably 800 μm or less. By setting the average cell size of the EPDM foamed material within the above-described range, the sealing properties and the flexibility can be excellent.

The EPDM foamed material obtained in this manner has a volume expansion ratio (density ratio before and after foaming) of, for example, five times or more, or preferably 25 times or more, and, for example, 30 times or less.

The EPDM foamed material has an apparent density (in accordance with JIS K 6767 (in 1999)) of, for example, 0.60 g/cm³ or less, preferably 0.50 g/cm³ or less, or more preferably 0.45 g/cm³ or less, and, for example, 0.01 g/cm³ or more. When the apparent density of the EPDM foamed material is within the above-described range, the flexibility of the EPDM foamed material can be excellent.

The EPDM foamed material has a 50% compressive load value (in accordance with JIS K 6767 (in 1999)) of, for example, 0.50 N/cm² or less, preferably 0.30 N/cm² or less, or more preferably 0.20 N/cm² or less, and, for example, 0.03 N/cm² or more, or preferably 0.05 N/cm² or more.

The EPDM foamed material has an 80% compressive load value (in accordance with JIS K 6767 (in 1999)) of, for example, 2.00 N/cm² or less, preferably 1.20 N/cm² or less, or more preferably 0.70 N/cm² or less, and, for example, 0.10 N/cm² or more, or preferably 0.20 N/cm² or more.

When the 50% compressive load value or the 80% compressive load value of the EPDM foamed material are within the above-described range, in a case where the EPDM foamed material is compressed to a member to seal the member, a load thereto can be reduced, so that the member can be easily sealed and deformation or destruction of the member can be suppressed.

The EPDM foamed material has a permanent compression set (in accordance with JIS K 6767 (in 1999)) obtained by being compressed by 50% at 40° C. for 22 hours to be then allowed to stand at 23° C. for 30 minutes of for example, 30% or less, preferably 20% or less, more preferably 10% or less, further more preferably 7.0% or less, or particularly preferably 3.0% or less.

The EPDM foamed material has a permanent compression set (in accordance with JIS K 6767 (in 1999)) obtained by being compressed by 50% at 40° C. for 22 hours to be then allowed to stand at 23° C. for 24 hours of, for example, 30% or less, preferably 15% or less, more preferably 5.0% or less, further more preferably 3.0% or less, or particularly preferably 1.0% or less.

When the permanent compression set under the above-described conditions is within the above-described range, a sag due to the permanent compression set at a normal temperature and a high temperature can be reduced and the shape can be restored, so that by following a surface to be sealed of the member, the sealing properties can be excellent.

The use of the EPDM foamed material is not particularly limited and the EPDM foamed material can be used as, for example, a vibration-proof material, a sound absorbing material, a sound insulation material, a dust-proof material, a heat insulating material, a buffer material, or a water-stop material, which seals a gap between various members for the purpose of, for example, damping, sound absorption, sound insulation, dust-proof, heat insulation, buffering, or water tight. To be more specific, the EPDM foamed material can be, for example, used in a gap between a casing of an automobile and a member (for example, tail light and the like) and a gap between a casing of an electricity/electrical apparatus and a member (for example, engine control unit (ECU) and the like).

The EPDM foamed material is obtained by foaming a rubber composition containing an ethylene-propylene-diene rubber and a thermoplastic resin having a melting point of 60 to 140° C.

The thermoplastic resin content with respect to 100 parts by mass of the ethylene-propylene-diene rubber is 5 to 50 parts by mass. The ethylene-propylene-diene rubber contains an ethylene-propylene-diene rubber having a diene amount of 4.0 mass % or more. Thus, the EPDM foamed material has an excellent permanent compression set and an excellent compressive load value, while having low density. Thus, the EPDM foamed material can easily seal a member with excellent sealing properties and can be preferably used as a sealing material.

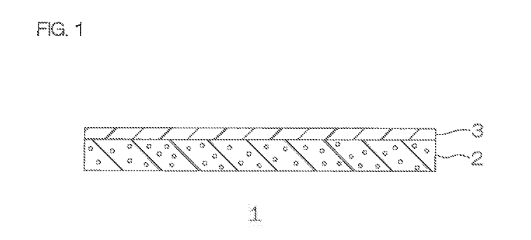

FIG. 1 shows a schematic configuration view illustrating one embodiment of a sealing material of the present invention.

That is, in FIG. 1, a sealing material 1 includes an EPDM foamed material 2 described above and a pressure-sensitive adhesive layer 3 provided on one surface (top surface) of the EPDM foamed material 2.

The pressure-sensitive adhesive layer 3 is, for example, formed of a known pressure-sensitive adhesive.

Examples of the pressure-sensitive adhesive include an acrylic pressure-sensitive adhesive, a rubber pressure-sensitive adhesive, a silicone pressure-sensitive adhesive, a polyester pressure-sensitive adhesive, a urethane pressure-sensitive adhesive, a polyamide pressure-sensitive adhesive, an epoxy pressure-sensitive adhesive, a vinyl alkyl ether pressure-sensitive adhesive, and a fluorine pressure-sensitive adhesive. In addition to these, an example of the pressure-sensitive adhesive also includes a hot melt pressure-sensitive adhesive.

These pressure-sensitive adhesives may be used alone or in combination of two or more.

As the pressure-sensitive adhesive, preferably, an acrylic pressure-sensitive adhesive and a rubber pressure-sensitive adhesive are used.

An example of the acrylic pressure-sensitive adhesive includes a pressure-sensitive adhesive mainly composed of an alkyl (meth)acrylate. The acrylic pressure-sensitive adhesive can be obtained by a known method.

The rubber pressure-sensitive adhesive can be obtained from, for example, a natural rubber and/or a synthetic rubber by a known method. To be more specific, examples of a rubber include a polyisobutylene rubber, a polyisoprene rubber, a chloroprene rubber, a butyl rubber, and a nitrile butyl rubber.

A form of the pressure-sensitive adhesive is not particularly limited and various forms such as an emulsion pressure-sensitive adhesive, a solvent pressure-sensitive adhesive, an oligomer pressure-sensitive adhesive, or a solid pressure-sensitive adhesive can be used.

The pressure-sensitive adhesive layer 3 has a thickness of for example, 10 μm or more, or preferably 50 m or more, and, for example, 10000 μm or less, or preferably 5000 μm or less.

A method for forming the sealing material 1 is not particularly limited and a known method can be used. To be specific, for example, the pressure-sensitive adhesive layer 3 is laminated on the top surface of the EPDM foamed material 2 by a known method.

According to the scaling material 1, the EPDM foamed material 2 having an excellent permanent compression set and an excellent compressive load value, while having low density, is included, so that the EPDM foamed material 2 can be easily brought into tight contact with a member and a gap between various members can be surely sealed.

In the embodiment in FIG. 1, the pressure-sensitive adhesive layer 3 is provided on the one surface only of the EPDM foamed material 2. Alternatively, for example, though not shown, the pressure-sensitive adhesive layer 3 can be also provided on both surfaces (the top and back surfaces) of the EPDM foamed material 2.

### EXAMPLES

While the present invention will be described hereinafter in further detail with reference to Examples and Comparative Examples, the present invention is not limited to these Examples and Comparative Examples. Specific numeral values such as mixing ratio (content ratio), property value, and parameter used in the following description can be replaced with the upper limit values (numeral values defined as “or less” or “less than”) or the lower limit values (numeral values defined as “or more” or “above”) of the respective descriptions such as mixing ratio (content ratio), property value, and parameter described in the above-described “DETAILED DESCRIPTION OF THE INVENTION”.

### Examples 1 to 22 and Comparative Examples 1 to 2

### (1) Production of EPDM Foamed Material

An EPDM, a processing auxiliary, a pigment, a filler, and a softener were blended at a mixing amount described in the mixing formulation shown in Table 1 or Table 2 to be kneaded with a 3 L pressurizing kneader, so that a first kneaded material was prepared.

Separately, a cross-linking agent, a cross-linking auxiliary, a foaming agent, and a foaming auxiliary were blended. Thereafter, the obtained mixture was blended into the first kneaded material to be kneaded with a 10-inch mixing roll, thereby preparing a rubber composition (second kneaded material) (kneading step).

Next, the rubber composition was extruded into a sheet shape having a thickness of about 8 mm by using a single screw extruder (45 mm φ), thereby producing a rubber composition sheet (molding step).

Subsequently, the rubber composition sheet was preheated at 140° C. for 20 minutes with an oven with internal air circulation. Thereafter, the temperature of the oven with internal air circulation was increased to 170° C. over 10 minutes, so that the rubber composition sheet was heated at 170° C. for 10 minutes to be foamed (foaming step) and in this way, an EPDM foamed material was produced.

### (2) Property Measurement

The properties of each of the EPDM foamed materials in Examples 1 to 22 and Comparative Examples 1 to 2 were measured by the following method. The results are shown in Table 1 or Table 2.

<Apparent Density>

The apparent density of each of the EPDM foamed materials was measured in accordance with JIS K 6767 (in 1999). To be specific, a skin layer of each of the EPDM foamed materials was removed and a test piece having a thickness of about 10 mm was produced. Thereafter, the mass was measured to calculate the mass per unit volume (apparent density).

<Compressive Load Value>

The compressive load value of each of the EPDM foamed materials was measured in accordance with JIS K 6767 (in 1999). To be specific, a skin layer of each of the EPDM foamed materials was removed and a test piece having a thickness of about 10 mm was produced. Thereafter, the test piece was compressed by 50% (or 80%) at a compression rate of 10 mm/min by using a compression testing machine to measure a compressive load value after 10 seconds of compression.

<Permanent Compression Set>

The permanent compression set of each of the EPDM foamed materials was measured in accordance with JIS K 6767 (in 1999). To be specific, the EPDM foamed material was disposed to be fixed in a compressed state of 50% via a spacer between two pieces of aluminum boards to be then allowed to stand at 40° C. for 22 hours. Thereafter, the resulting EPDM foamed material was taken out to be released from the two pieces of aluminum boards to be then allowed to stand at 23° C. for 30 minutes (or 24 hours). After the compression and leave-in test, the permanent compression set was obtained by the following formula.

Permanent compression set (%6)=[(initial thickness−thickness after test)/initial thickness]×100

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| EPDM | EPT8030M (diene amount of 9.5%) | | 70 | 70 | 70 | 70 | 70 | 70 | 70 |
| | EP24 (diene amount of 4.5%) | | 30 | 30 | 30 | 30 | 30 | 30 | 30 |
| | EP22 (diene amount of 4.5%) | | — | — | — | — | — | — | — |
| | EP93 (diene amount of 2.7%) | | — | — | — | — | — | — | — |
| | EP43 (diene amount of 1.5%) | | — | — | — | — | — | — | — |
| Thermoplastic | Polyethylene | Nipolon Hard 1200 | 8 | 12 | 16 | — | — | — | — |
| Resin | | (melting point of 129° C.) | | | | | | | |
| | | PETROSEN 353 | — | — | — | 10 | 20 | 30 | 40 |
| | | (melting point of 98° C.) | | | | | | | |
| | | PETROSEN 251R | — | — | — | — | — | — | — |
| | | (melting point of 108° C.) | | | | | | | |
| | | PETROSEN 209 | — | — | — | — | — | — | — |
| | | (melting point of 108° C.) | | | | | | | |
| | | NOVATEC LC720 | — | — | — | — | — | — | — |
| | | (melting point of 110° C.) | | | | | | | |
| | EVA | EVA (550) | — | — | — | — | — | — | — |
| | | (melting point of 89° C.) | | | | | | | |
| Processing | Stearic Acid | | 3 | 3 | 3 | 3 | 3 | 3 | 3 |
| Auxiliary | | | | | | | | | |
| Pigment | Carbon Black | | 10 | 10 | 10 | 10 | 10 | 10 | 10 |
| Filler | Calcium Carbonate | | 180 | 180 | 180 | 180 | 180 | 180 | 180 |
| Softener | Paraffin Pellet | | 5 | 5 | 5 | 5 | 5 | 5 | 5 |
| | Process Oil | | 40 | 40 | 40 | 40 | 40 | 40 | 40 |
| | Asphalt | | 42 | 38 | 34 | 40 | 30 | 20 | 10 |
| Cross-Linking | Sulfur | | 2 | 2 | 2 | 2 | 2 | 2 | 2 |
| Agent | | | | | | | | | |
| Cross-Linking | Thiazoles | | 1 | 1 | 1 | 1 | 1 | 1 | 1 |
| Auxiliary | Dithiocarbamates | | 1 | 1 | 1 | 1 | 1 | 1 | 1 |
| | Thioureas | | 2 | 2 | 2 | 2 | 2 | 2 | 2 |
| Foaming | Azodicarbonamide | | 35 | 35 | 35 | 35 | 35 | 35 | 35 |
| Agent | Sodium Hydrogen Carbonate | | 1 | 1 | 1 | 1 | 1 | 1 | 1 |
| Foaming | Urea Foaming Auxiliary | | 4 | 4 | 4 | 4 | 4 | 4 | 4 |
| Auxiliary | Zinc Oxide | | 5 | 5 | 5 | 5 | 5 | 5 | 5 |
| | Apparent Density (g/cm³) | | 0.041 | 0.041 | 0.039 | 0.043 | 0.045 | 0.046 | 0.047 |
| | Compressive | 50% Compressive Load | 0.12 | 0.13 | 0.12 | 0.12 | 0.15 | 0.17 | 0.19 |
| | Load (N/cm²) | 80% Compressive Load | 0.41 | 0.46 | 0.46 | 0.52 | 0.74 | 0.65 | 0.80 |
| | Permanent | 23° C., after 30 min | 29.1 | 18.5 | 16.7 | 9.8 | 6.5 | 9.7 | 8.8 |
| | Compression | 23° C., after 24 hr | 23.7 | 10.8 | 6.4 | 4.7 | 3.6 | 4.7 | 4.5 |
| | Set (%) | | | | | | | | |

| | | | | | | Comp. | Comp. |
|---|---|---|---|---|---|---|---|
| | | | Ex. 8 | Ex. 9 | Ex. 10 | Ex. 1 | Ex. 2 |
| EPDM | EPT8030M (diene amount of 9.5%) | | 70 | 70 | 70 | 70 | 70 |
| | EP24 (diene amount of 4.5%) | | 30 | 30 | 30 | 30 | 30 |
| | EP22 (diene amount of 4.5%) | | — | — | — | — | — |
| | EP93 (diene amount of 2.7%) | | — | — | — | — | — |
| | EP43 (diene amount of 1.5%) | | — | — | — | — | — |
| Thermoplastic | Polyethylene | Nipolon Hard 1200 | — | — | — | — | 4 |
| Resin | | (melting point of 129° C.) | | | | | |
| | | PETROSEN 353 | — | — | — | — | — |
| | | (melting point of 98° C.) | | | | | |
| | | PETROSEN 251R | 20 | — | — | — | — |
| | | (melting point of 108° C.) | | | | | |
| | | PETROSEN 209 | — | 20 | — | — | — |
| | | (melting point of 108° C.) | | | | | |
| | | NOVATEC LC720 | — | — | 20 | — | — |
| | | (melting point of 110° C.) | | | | | |
| | EVA | EVA (550) | — | — | — | — | — |
| | | (melting point of 89° C.) | | | | | |

| | | | | | | |
|---|---|---|---|---|---|---|
| Processing | Stearic Acid | 3 | 3 | 3 | 3 | 3 |
| Auxiliary | | | | | | |
| Pigment | Carbon Black | 10 | 10 | 10 | 10 | 10 |
| Filler | Calcium Carbonate | 180 | 180 | 180 | 180 | 180 |
| Softener | Paraffin Pellet | 5 | 5 | 5 | 5 | 5 |
| | Process Oil | 40 | 40 | 40 | 40 | 40 |
| | Asphalt | 30 | 30 | 30 | 50 | 46 |
| Cross-Linking | Sulfur | 2 | 2 | 2 | 2 | 2 |
| Agent | | | | | | |
| Cross-Linking | Thiazoles | 1 | 1 | 1 | 1 | 1 |
| Auxiliary | Dithiocarbamates | 1 | 1 | 1 | 1 | 1 |
| | Thioureas | 2 | 2 | 2 | 2 | 2 |
| Foaming | Azodicarbonamide | 35 | 35 | 35 | 35 | 35 |
| Agent | Sodium Hydrogen Carbonate | 1 | 1 | 1 | 1 | 1 |
| Foaming | Urea Foaming Auxiliary | 4 | 4 | 4 | 4 | 4 |
| Auxiliary | Zinc Oxide | 5 | 5 | 5 | 5 | 5 |
| | Apparent Density (g/cm³) | 0.041 | 0.041 | 0.046 | 0.040 | 0.041 |

| | | | | | | |
|---|---|---|---|---|---|---|
| Compressive | 50% Compressive Load | 0.17 | 0.14 | 0.20 | 0.08 | 0.11 |
| Load (N/cm²) | 80% Compressive Load | 0.59 | 0.50 | 0.73 | 0.38 | 0.41 |
| Permanent | 23° C., after 30 min | 5.3 | 4.8 | 9.3 | 45 | 38 |
| Compression | 23° C., after 24 hr | 2.5 | 2.3 | 4.1 | 40 | 33 |
| Set (%) | | | | | | |

TABLE 2

| | | | Ex. 11 | Ex. 12 | Ex. 13 | Ex. 14 | Ex. 15 | Ex. 16 | Ex. 17 |
|---|---|---|---|---|---|---|---|---|---|
| EPDM | EPT8030M (diene amount of 9.5%) | | 70 | 70 | 70 | 70 | 30 | — | — |
| | EP24 (diene amount of 4.5%) | | 30 | 30 | 30 | 30 | 70 | 70 | 70 |
| | EP22 (diene amount of 4.5%) | | — | — | — | — | — | 30 | — |
| | EP93 (diene amount of 2.7%) | | — | — | — | — | — | — | 30 |
| | EP43 (diene amount of 1.5%) | | — | — | — | — | — | — | — |
| Thermoplastic | Polyethylene | Nipolon Hard 1200 | — | — | — | — | — | — | — |
| Resin | | (melting point of 129° C.) | | | | | | | |
| | | PETROSEN 353 | — | — | — | — | — | — | — |
| | | (melting point of 98° C.) | | | | | | | |
| | | PETROSEN 251R | — | — | — | — | — | — | — |
| | | (melting point of 108° C.) | | | | | | | |
| | | PETROSEN 209 | — | — | — | — | 20 | 20 | 20 |
| | | (melting point of 108° C.) | | | | | | | |
| | | NOVATEC LC720 | — | — | — | — | — | — | — |
| | | (melting point of 110° C.) | | | | | | | |
| | EVA | EVA (550) | 10 | 20 | 30 | 40 | — | — | — |
| | | (melting point of 89° C.) | | | | | | | |
| Processing | Stearic Acid | | 3 | 3 | 3 | 3 | 3 | 3 | 3 |
| Auxiliary | | | | | | | | | |
| Pigment | Carbon Black | | 10 | 10 | 10 | 10 | 10 | 10 | 10 |
| Filler | Calcium Carbonate | | 180 | 180 | 180 | 180 | 180 | 180 | 180 |
| Softener | Paraffin Pellet | | 5 | 5 | 5 | 5 | 5 | 5 | 5 |
| | Process Oil | | 40 | 40 | 40 | 40 | 40 | 40 | 40 |
| | Asphalt | | 40 | 30 | 20 | 10 | 30 | 30 | 30 |
| Cross-Linking | Sulfur | | 2 | 2 | 2 | 2 | 2 | 2 | 2 |
| Agent | | | | | | | | | |
| Cross-Linking | Thiazoles | | 1 | 1 | 1 | 1 | 1 | 1 | 1 |
| Auxiliary | Dithiocarbamates | | 1 | 1 | 1 | 1 | 1 | 1 | 1 |
| | Thioureas | | 2 | 2 | 2 | 2 | 1 | 1 | 1 |
| Foaming | Azodicarbonamide | | 35 | 35 | 35 | 35 | 38 | 38 | 38 |
| Agent | Sodium Hydrogen Carbonate | | 1 | 1 | 1 | 1 | 3 | 3 | 3 |
| Foaming | Urea Foaming Auxiliary | | 4 | 4 | 4 | 4 | 4 | 4 | 4 |
| Auxiliary | Zinc Oxide | | 5 | 5 | 5 | 5 | 5 | 5 | 5 |
| | Apparent Density (g/cm³) | | 0.043 | 0.046 | 0.048 | 0.050 | 0.041 | 0.041 | 0.040 |
| | Compressive | 50% Compressive Load | 0.13 | 0.19 | 0.21 | 0.27 | 0.21 | 0.22 | 0.18 |
| | Load (N/cm²) | 80% Compressive Load | 0.46 | 0.56 | 0.72 | 0.82 | 0.50 | 0.66 | 0.41 |
| | Permanent | 23° C., after 30 min | 8.8 | 7.6 | 8.2 | 9.3 | 1.3 | 2.3 | 1.7 |
| | Compression | 23° C., after 24 hr | 3.7 | 4.2 | 3.6 | 3.5 | 0.3 | 1.6 | 1.1 |
| | Set (%) | | | | | | | | |

| | | | Ex. 18 | Ex. 19 | Ex. 20 | Ex. 21 | Ex. 22 |
|---|---|---|---|---|---|---|---|
| EPDM | EPT8030M (diene amount of 9.5%) | | — | 70 | — | — | — |
| | EP24 (diene amount of 4.5%) | | 70 | 30 | 30 | 30 | 30 |
| | EP22 (diene amount of 4.5%) | | — | — | 70 | — | — |
| | EP93 (diene amount of 2.7%) | | — | — | — | 70 | — |
| | EP43 (diene amount of 1.5%) | | 30 | — | — | — | 70 |
| Thermoplastic | Polyethylene | Nipolon Hard 1200 | — | — | — | — | — |
| Resin | | (melting point of 129° C.) | | | | | |
| | | PETROSEN 353 | — | — | — | — | — |
| | | (melting point of 98° C.) | | | | | |
| | | PETROSEN 251R | — | — | — | — | — |
| | | (melting point of 108° C.) | | | | | |
| | | PETROSEN 209 | 20 | 20 | 20 | 20 | 20 |
| | | (melting point of 108° C.) | | | | | |
| | | NOVATEC LC720 | — | — | — | — | — |
| | | (melting point of 110° C.) | | | | | |
| | EVA | EVA (550) | — | — | — | — | — |
| | | (melting point of 89° C.) | | | | | |

| | | | | | | |
|---|---|---|---|---|---|---|
| Processing | Stearic Acid | 3 | 3 | 3 | 3 | 3 |
| Auxiliary | | | | | | |
| Pigment | Carbon Black | 10 | 10 | 10 | 10 | 10 |
| Filler | Calcium Carbonate | 180 | 180 | 180 | 180 | 180 |
| Softener | Paraffin Pellet | 5 | 5 | 5 | 5 | 5 |
| | Process Oil | 40 | 40 | 40 | 40 | 40 |
| | Asphalt | 30 | 30 | 30 | 30 | 30 |
| Cross-Linking | Sulfur | 2 | 2 | 2 | 2 | 2 |
| Agent | | | | | | |
| Cross-Linking | Thiazoles | 1 | 1 | 1 | 1 | 1 |
| Auxiliary | Dithiocarbamates | 2 | 1 | 1 | 1 | 2 |
| | Thioureas | 1 | 1 | 1 | 2 | 2 |
| Foaming | Azodicarbonamide | 38 | 38 | 38 | 38 | 38 |
| Agent | Sodium Hydrogen Carbonate | 3 | 3 | 3 | 3 | 3 |
| Foaming | Urea Foaming Auxiliary | 4 | 4 | 4 | 4 | 4 |
| Auxiliary | Zinc Oxide | 5 | 5 | 5 | 5 | 5 |
| | Apparent Density (g/cm³) | 0.042 | 0.060 | 0.044 | 0.050 | 0.046 |

| | | | | | | |
|---|---|---|---|---|---|---|
| Compressive | 50% Compressive Load | 0.47 | 0.30 | 0.14 | 0.24 | 0.16 |
| Load (N/cm²) | 80% Compressive Load | 0.41 | 1.16 | 0.62 | 0.70 | 0.56 |
| Permanent | 23° C., after 30 min | 3.2 | 2.4 | 5.1 | 2.3 | 4.5 |
| Compression | 23° C., after 24 hr | 0.8 | 1.0 | 0.7 | 0.7 | 0.7 |
| Set (%) | | | | | | |

The numeral values in Tables 1 and 2 show the number of parts by mass in each of the components. For the abbreviations described in Tables 1 and 2, the details are given in the following.
EPT 8030M: second EPDM, containing a long chain branching structure, diene (5-ethylidene-2-norbornene) content of 9.5 mass %, catalyst: metallocene catalyst, 32 (ML (1+4) at 100° C.), manufactured by Mitsui Chemicals, Inc.
EP 24: first EPDM, diene (5-ethylidene-2-norbornene) content of 4.5 mass %, catalyst: vanadium catalyst, 42 (ML (1+4) at 125° C.), manufactured by JSR Corporation
EP 22: first EPDM, diene (5-ethylidene-2-norbornene) content of 4.5 mass %, catalyst: vanadium catalyst, 27 (ML (1+4) at 125° C.), manufactured by JSR Corporation
EP 93: low diene EPDM, diene (5-ethylidene-2-norbornene) content of 2.7 mass %, catalyst vanadium catalyst, 31 (ML (1+4) at 125° C.), manufactured by JSR Corporation
EP 43: low diene EPDM, diene (5-ethylidene-2-norbornene) content of 1.5 mass %, catalyst: vanadium catalyst, 28 (ML (1+4) at 125° C.), manufactured by JSR Corporation
Nipolon Hard 1200: high density polyethylene, melting point of 129° C., density of 952 kg/m³, MFR of 21 g/10 min, manufactured by Tosoh Corporation
PETROSEN 353: low density polyethylene, melting point of 98° C., density of 915 kg/m³, MFR of 145 g/10 min, manufactured by Tosoh Corporation
PETROSEN 251R: low density polyethylene, melting point of 108° C., density of 924 kg/m³, MFR of 3.0 g/10 min, manufactured by Tosoh Corporation
PETROSEN 209: low density polyethylene, melting point of 108° C., density of 924 kg/m³, MFR of 45 g/10 min, manufactured by Tosoh Corporation
NOVATEC LC720: low density polyethylene, melting point of 110° C., density of 922 kg/m³, MFR of 9.4 g/l 0 min, manufactured by Japan Polyethylene Corporation
EVA (550): ethylene-vinyl acetate copolymer, melting point of 89° C., manufactured by Du Pont-Mitsui Fluorochemicals Co., Ltd.
Stearic Acid: “stearic acid powder Sakura”, manufactured by NOF CORPORATION
Carbon Black: “Asahi #50”, average particle size of 80 μm, manufactured by ASAHI CARBON CO., LTD.
Calcium Carbonate: heavy calcium carbonate, manufactured by MARUO CALCIUM CO., LTD.
Paraffin Pellet: “Parapere 130”, manufactured by Taniguchi Petroleum Corp.
Process Oil: “Diana Process Oil PW-90”, parafinic process oil, manufactured by Idemitsu Kosan Co., Ltd.
Asphalt: blown asphalt, “Trumbull Base Asphalt 4402”, manufactured by Owens Corning Sales LLC Trumbull
Sulfur: “ALPHAGRAN S-50EN”, sulfur master batch, manufactured by Touchi Co., Ltd.
Thiazoles: “NOCCELER M”, 2-mercaptobenzothiazole, manufactured by OUCHI SHINKO CHEMICAL INDUSTRIAL CO., LTD.
Dithiocarbamates: “NOCCELER ZTC”, zinc dibenzyldithiocarbamate, manufactured by OUCHI SHINKO CHEMICAL INDUSTRIAL CO., LTD.
Thioureas: “NOCCELER BUR”, N,N′-dibutylthiourea: manufactured by OUCHI SHINKO CHEMICAL INDUSTRIAL CO., LTD.
Azodicarbonamide: “VINYFOR AC#LQ K2”, manufactured by EIWA CHEMICAL IND. CO., LTD.
Sodium Hydrogen Carbonate: “CELLBORN FE-507”, manufactured by EIWA CHEMICAL IND. CO., LTD.
Urea Foaming Auxiliary: “CELLPASTE KS”, manufactured by EIWA CHEMICAL IND. CO., LTD.
Zinc Oxide: second-class zinc oxide, manufactured by MITSUI MINING & SMELTING CO., LTD.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. An ethylene-propylene-diene rubber foamed material obtained by foaming a rubber composition containing an ethylene-propylene-diene rubber and a thermoplastic resin having a melting point of 60 to 140° C., wherein
the thermoplastic resin content with respect to 100 parts by mass of the ethylene-propylene-diene rubber is 5 to 50 parts by mass and
the ethylene-propylene-diene rubber includes an ethylene-propylene-diene rubber having a diene amount of 4.0 mass % or more.

2. The ethylene-propylene-diene rubber foamed material according to claim 1, wherein
the content ratio of the ethylene-propylene-diene rubber having the diene amount of 4.0 mass % or more in the ethylene-propylene-diene rubber is 20 mass % or more.

3. The ethylene-propylene-diene rubber foamed material according to claim 1, wherein
the ethylene-propylene-diene rubber having the diene amount of 4.0 mass % or more is an ethylene-propylene-diene rubber having a diene amount of 4.0 mass % or more and less than 7.0 mass %.

4. The ethylene-propylene-diene rubber foamed material according to claim 1, wherein
the ethylene-propylene-diene rubber includes an ethylene-propylene-diene rubber having the diene amount of 4.0 mass % or more and less than 7.0 mass % and an ethylene-propylene-diene rubber having a diene amount of 7.0 mass % or more and 15.0 mass % or less.

5. The ethylene-propylene-diene rubber foamed material according to claim 4, wherein
the content ratio of the ethylene-propylene-diene rubber having the diene amount of 4.0 mass % or more and less than 7.0 mass % in the ethylene-propylene-diene rubber is 20 mass % or more and
the content ratio of the ethylene-propylene-diene rubber having the diene amount of 7.0 mass % or more and 15.0 mass % or less in the ethylene-propylene-diene rubber is 20 mass % or more.

6. The ethylene-propylene-diene rubber foamed material according to claim 4, wherein
the mass ratio of the ethylene-propylene-diene rubber having the diene amount of 4.0 mass % or more and less than 7.0 mass % to the ethylene-propylene-diene rubber having the diene amount of 7.0 mass % or more and 15.0 mass % or less is 30:70 to 100:0.

7. The ethylene-propylene-diene rubber foamed material according to claim 4, wherein
the ethylene-propylene-diene rubber having the diene amount of 7.0 mass % or more and 15.0 mass % or less has a long chain branching structure.

8. The ethylene-propylene-diene rubber foamed material according to claim 1, wherein
the ethylene-propylene-diene rubber having the diene amount of 4.0 mass % or more is obtained by a copolymer of ethylene, propylene, and dienes and the dienes contain 5-ethylidene-2-norbornene.

9. The ethylene-propylene-diene rubber foamed material according to claim 1, wherein
the rubber composition further contains 40 parts by mass or more of a foaming agent with respect to 100 parts by mass of the ethylene-propylene-diene rubber.

10. The ethylene-propylene-diene rubber foamed material according to claim 1, wherein
a 50% compressive load value is 0.03 to 0.50 N/cm² and an 80% compressive load value is 0.10 to 2.00 N/cm².

11. A scaling material comprising:
the ethylene-propylene-diene rubber foamed material according to claim 1 and
a pressure-sensitive adhesive layer provided on at least one surface of the ethylene-propylene-diene rubber foamed material.
